(19) United States
(12) Patent Application Publication
(10) Pub. No.: US 2019/0282972 A1
(43) Pub. Date: Sep. 19, 2019

(54) OXYGENATED FOAMY BEVERAGE SYSTEM, METHOD, AND APPARATUS

(71) Applicant: Gregory Bershadsky, Indian Lake Estates, FL (US)

(72) Inventor: Gregory Bershadsky, Indian Lake Estates, FL (US)

(21) Appl. No.: 15/922,872

(22) Filed: Mar. 15, 2018

(51) Int. Cl. B01F 3/04; A23L 2/54; A23L 2/40; B01F 15/00

(52) U.S. Cl. CPC B01F 3/04453; A23L 2/54; A23L 2/40; B01F 2215/0022; B01F 15/00123; A23V 2002/00; B01F 2003/04879; B01F 3/04794

(57) ABSTRACT

A method, system and apparatus for making oxygenated foamy beverages are described.

### TECHNICAL FIELD

Embodiments relate generally to machines for making beverages, and more particularly, to a method, system and apparatus for making oxygenated foamy beverages.

### SUMMARY

Some implementations can include a method, system and apparatus for making oxygenated foamy beverages. For example, in some implementations, a system can include a controller, and an oxygen supply coupled to the controller and having an oxygen dispensing outlet configured to provide oxygen to a drink mix having a foaming agent. The system can also include an agitator coupled to the controller and having a distal end configured to agitate and aerate the drink mix with the foaming agent, and a control panel coupled to the controller, the control panel having a plurality of controls, each control corresponding to a mode of operation of the system.

In a first mode, the controller activates the oxygen supply and the agitator causing oxygen gas to be provided to the drink mix via the oxygen dispensing outlet and the agitator to rotate to create foam from the foaming agent within the drink mix to make an oxygenated foamy beverage.

In a second mode, the controller activates the oxygen supply and the agitator causing oxygen gas to be provided to the drink mix via the oxygen dispensing outlet to make an oxygenated beverage.

In a third mode, the controller activates the agitator causing the agitator to rotate to create foam from the foaming agent within the drink mix to make a foamy beverage.

In some implementations, the oxygen supply can include an oxygen concentrator. In some implementations, the oxygen supply includes an oxygen generator. In some implementations, the oxygen supply includes an interface to an oxygen tank. The foaming agent can include methylcellulose.

### BRIEF DESCRIPTION OF THE DRAWINGS

FIG. 1 is a diagram of an example method for making an oxygenated foamy beverage in accordance with some implementations.

FIG. 2 is a diagram of an example system and apparatus for making an oxygenated foamy beverage in accordance with some implementations.

FIG. 3 is a diagram of an example apparatus for making oxygenated foamy beverages in accordance with some implementations.

FIG. 4 is a diagram of an example apparatus for making oxygenated foamy beverages in accordance with some implementations.

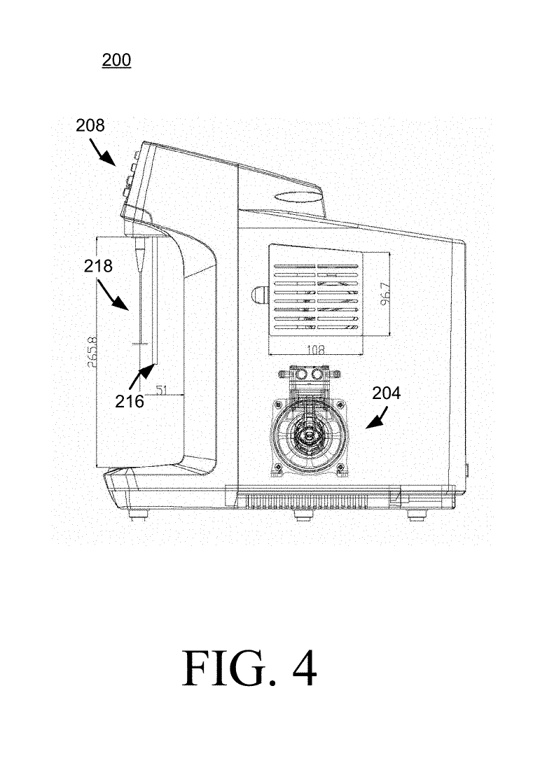

FIG. 5 is a diagram of an example computer system for making oxygenated foamy beverages in accordance with at least one implementation.

FIG. 6 is a diagram of an example container for making oxygenated foamy beverages in accordance with some implementations.

### DETAILED DESCRIPTION

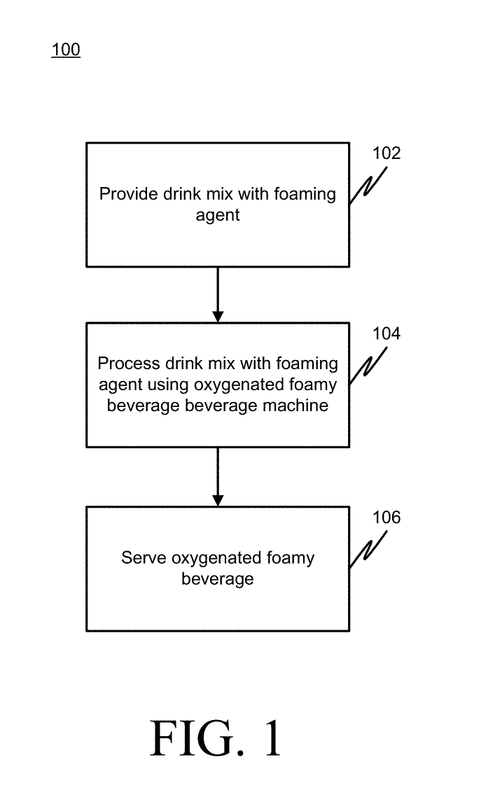

FIG. 1 is a diagram of an example method 100 for making an oxygenated foamy beverage in accordance with some implementations. At 102, a liquid drink mix with a foaming agent is provided. The liquid drink mix can include a naturally or artificially flavored liquid drink mix that can be non-caloric and low in carbohydrates, in some implementations. It will be appreciated that in some implementations, the liquid drink mix can include natural or artificial sweeteners, alcohol, protein, and/or caffeine. The drink mix can include a foaming agent such as methylcellulose (e.g., Methocel F50 food grade methylcellulose, Methocel is a trademark of Dow Chemical). In other implementations, the foaming agent can include liquid egg whites (optionally pasteurized), egg white powder, licorice, or any suitable foaming agent. The method continues to 104.

At 104, the drink mix with the foaming agent is processed by an oxygenated foamy beverage making apparatus or system (e.g., 200 or 500). Oxygen gas can be supplied into the drink mix via a supply outlet that provides oxygen gas into the liquid drink mix. An agitator (or aerator) can rotate to stir, aerate and agitate the drink mix causing the foaming agent to foam and capture some of the oxygen within the bubbles of the foam. The oxygen gas and the agitation can be provided to the drink mix until the oxygenated foamy beverage reaches a desired consistency or until a predetermined amount of time elapses. The method continues to 106.

At 106, the oxygenated foamy beverage is ready to be served.

In some implementations, the method can include oxygenated drink mix preparation including 1) adding a foaming agent in powder form at time of beverage preparation or 2) preparing a liquid drink mix or concentrated drink mix that includes flavorings and the foaming agent pre-dissolved in a liquid form that is “ready to make” into an oxygenated foamy beverage as described herein. For concentrated drink mixes, an appropriate amount of water may be added at the time the beverage is being made from the concentrate.

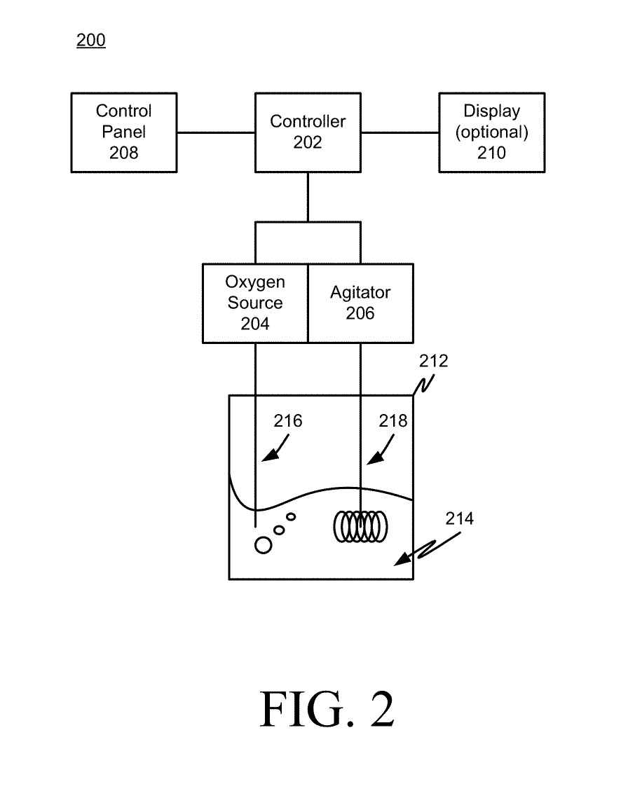

FIG. 2 is a diagram of an example system/apparatus 200 for making an oxygenated foamy beverage in accordance with some implementations. The system/apparatus includes a controller 202, an oxygen source 204, an agitator 206, a control panel 208, an optional display 210, a beverage container 212, a liquid drink mix with foaming agent 214, an oxygen dispensing outlet 216, and an agitator distal end 218. It will be appreciated that the oxygen source 204 and agitator 206 could be integrated into a single apparatus (e.g., 200) or can be in separate devices (e.g., one device for oxygenating the beverage and a separate device for agitating and creating foam.

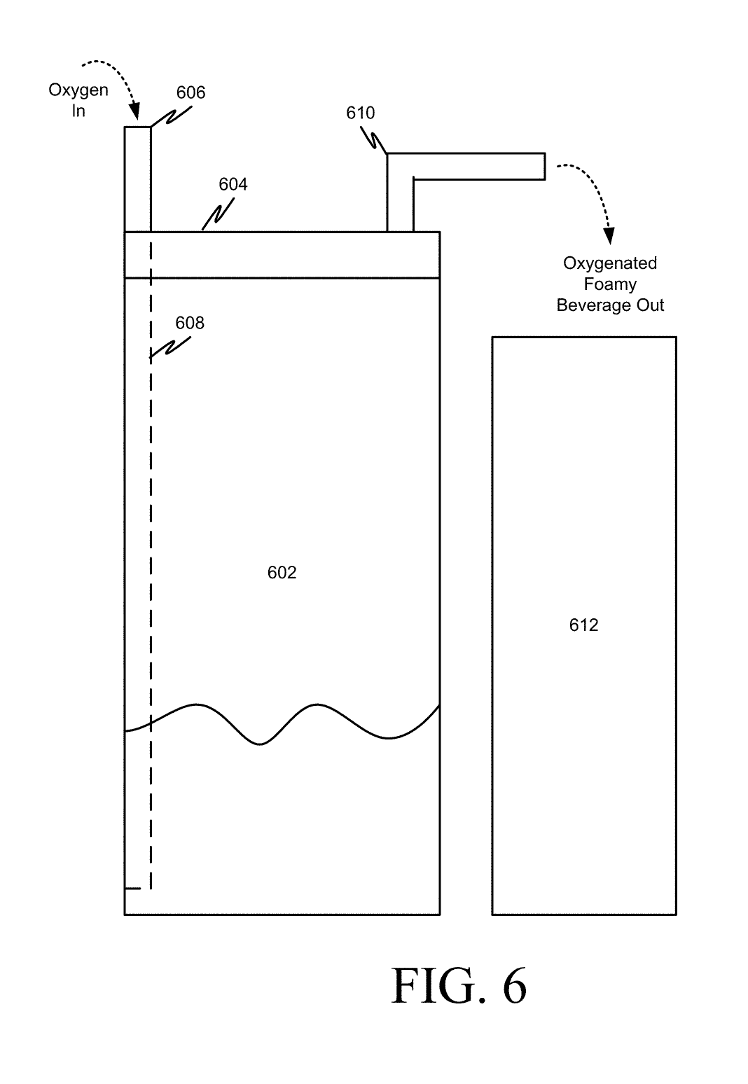

In operation, the oxygenated foamy beverage container 212 (e.g., a cup) is provided with a drink mix having a foaming agent 214. The container 212 is placed so that the oxygen dispensing outlet 216 and the agitator distal end 218 contact the liquid drink mix 214. A user selects a mode of operation (e.g., oxygenated foamy beverage) from the control panel 208 by making a selection from a touch screen or pressing a button. The container 212 can include a container, as shown in FIG. 6 at 602, that has a lid 604 with a connection 606 for receiving oxygen from the oxygen source 204, a passage 608 for transferring received oxygen from the connection 606 to the bottom of the container 602 so the oxygen gas can bubble into a liquid mixture in the container 602. The container 602 can also included an outlet 610 for providing the oxygenated foamy beverage from the container 602 to a serving cup 612.

The controller 202 receives the mode of operation selection and activates one or both of the oxygen source 204 and/or the agitator 206.

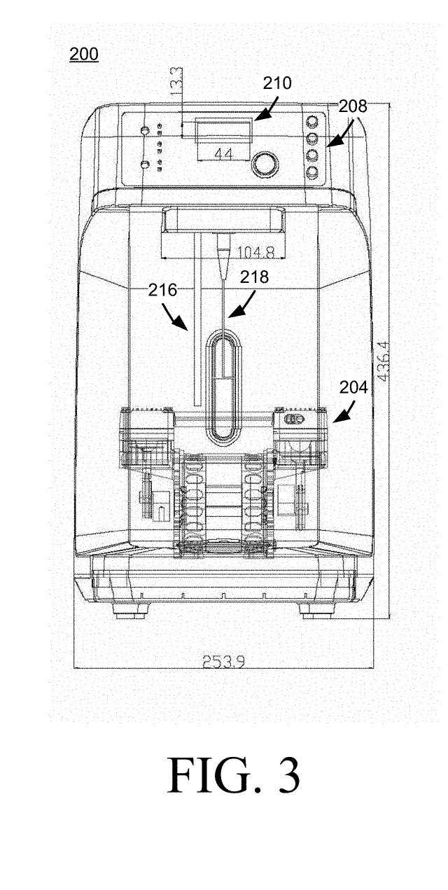

FIG. 3 are diagrams of an example apparatus for making oxygenated foamy beverages in accordance with some implementations.

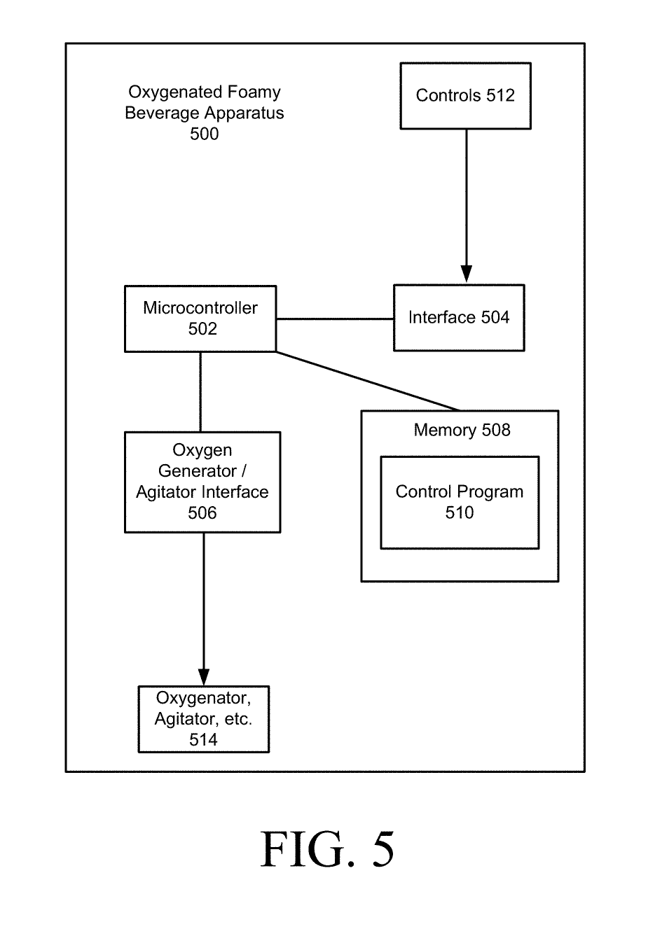

FIG. 5 is a diagram of an example oxygenated foamy beverage apparatus 500 in accordance with at least one implementation. The apparatus 500 includes a processor 502 (e.g., microcontroller or other suitable control circuitry), controls interface 504, oxygen generator/agitator interface 506, memory 508, controls 512, oxygen generator, agitator 514. The memory 508 can include an oxygenated foamy beverage apparatus control program 510.

In operation, the processor 502 may execute the application 510 stored in the memory 508. The application 510 can include software instructions that, when executed by the processor, cause the processor to perform operations for making oxygenated foamy beverages in accordance with the present disclosure (e.g., performing one or more of steps 102-106 described above).

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable arts from the function description provided herein and with a general basic knowledge of the software engineering and music production and performance arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, a method, system and apparatus for making oxygenated foamy beverages.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A system for making oxygenated foamy beverages, the system comprising:
a controller;
an oxygen supply coupled to the controller and having an oxygen dispensing outlet configured to provide oxygen to a drink mix having a foaming agent;
an agitator coupled to the controller and having a distal end configured to agitate and aerate the drink mix with the foaming agent; and
a control panel coupled to the controller, the control panel having a plurality of controls, each control corresponding to a mode of operation of the system,
wherein in a first mode, the controller activates the oxygen supply and the agitator causing oxygen gas to be provided to the drink mix via the oxygen dispensing outlet and the agitator to rotate to create foam from the foaming agent within the drink mix to make an oxygenated foamy beverage,
wherein in a second mode, the controller activates the oxygen supply and the agitator causing oxygen gas to be provided to the drink mix via the oxygen dispensing outlet to make an oxygenated beverage, and
wherein in a third mode, the controller activates the agitator causing the agitator to rotate to create foam from the foaming agent within the drink mix to make a foamy beverage.

2. The system of claim 1, wherein the oxygen supply includes an oxygen concentrator.

3. The system of claim 1, wherein the oxygen supply includes an oxygen generator.

4. The system of claim 1, wherein the oxygen supply includes an interface to an oxygen tank.

5. The system of claim 1, wherein the foaming agent includes methylcellulose.

6. A system for making oxygenated foamy beverages, the system comprising:
a controller;
an oxygen supply coupled to the controller and having an oxygen dispensing outlet configured to provide oxygen to a drink mix having a foaming agent;
a control panel coupled to the controller, the control panel having a plurality of controls, each control corresponding to a mode of operation of the system; and
a container having a lid with a connection for receiving oxygen from the oxygen supply, a passage for transferring received oxygen from the connection to a bottom of the container to cause oxygen gas to bubble into a liquid mixture in the container, wherein the container also includes an outlet for providing oxygenated foamy beverage generated in the container to a serving cup.
